(19) United States
(12) Patent Application Publication
(10) Pub. No.: US 2017/0107351 A1
(43) Pub. Date: Apr. 20, 2017

(54) BIOHYDROGENATED PLASTICS

(71) Applicant: Biovation Acquisition Company, Broadway, NC (US)

(72) Inventors: Michael Riebel, Mankato, MN (US); Milton Riebel, Mankato, MN (US)

(21) Appl. No.: 15/139,729

(22) Filed: Apr. 27, 2016

Related U.S. Application Data
(63) Continuation of application No. 14/453,082, filed on Aug. 6, 2014, now abandoned.
(60) Provisional application No. 61/862,789, filed on Aug. 6, 2013.

(51) Int. Cl. C08K 5/103

(52) U.S. Cl. CPC C08K 5/103

(57) ABSTRACT

A plastic composition may include a plastic or bioplastic portion and about 0.5%-50% hydrogenated saturated triglyceride. A method of making a plastic processing additive may include blending a hydrogenated saturated triglyceride with a second material to form an additive composition and pelletizing the additive composition. A pellet for plastics processing may include a first component comprising a hydrogenated saturated triglyceride and a second component comprising one of a wood product, a bioplastic, or a filler.

### CROSS-REFERENCE TO RELATED APPLICATIONS

This application claims priority to U.S. provisional patent application No. 61/862,789 filed on Aug. 6, 2013, entitled “Biohydrogenated Plastics/Bioplastics and Biohydrogenated Plastic Additives for Alloying Plastics, Bioplastics, and Filled Plastics Compositions and Methods,” the content of which is hereby incorporated by reference herein in its entirety.

### FIELD OF THE INVENTION

The present application relates to biohydrogenated plastics, biohydrogenated bioplastics, and/or biohydrogenated plastic additives. More particularly, the present application relates to plastics, bioplastics, and/or additives therefor that include hydrogenated saturated triglycerides (HST) such as soy HST. Still more particularly, the present application relates to plastics, bioplastics, and/or additives therefor where the amount of plastic in a composition with HST may be relatively low compared to compositions not including HST.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Plastic prices continue to climb and plastics continue to be used for more applications. Plastic or bioplastic alloys are based on the addition of other materials into a base plastic or base bioplastic through plastic compounding processes. Various fillers, fibers, minerals, additives, mixed plastics, colorants, starches, proteins and other materials may be added to plastics or bioplastics to adjust material performance, aesthetics, and the like. The addition of some materials, such as fillers, fibers, and minerals may create higher viscosities than neat plastic, which may slow processing speeds and create high kinetic shear issues in compounding materials. In some cases, in highly filled materials such as wood plastic composites, starch filled bioplastics, and other filled plastics, issues with lubrication, material coupling, and flow rate adjustment may be particularly exposed.

Petrochemical lubricants have been used, but these lubricants may have numerous limitations. In particular, these lubricants may generate volatile organic compounds (VOC's) that can be generally bad for the environment and unhealthy for process operators. In addition, petrochemical lubricants or processing aids tend to reduce material coupling triggering the use of a secondary petrochemical coupling agent.

In addition to issues relating to lubrication, material coupling and flow rate, fine powders such as wood flour, minerals, starches, and other fine powders may be difficult to feed with conventional plastic pellets during extrusion or extrusion compounding processes. Still further, compounding powdered fillers, additives, and colorant may require a high degree of energy and expensive processing equipment with limited production outputs.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

In one embodiment, a plastic composition may be provided. The plastic composition may include a plastic or bioplastic portion. The plastic composition may also include about 0.5%-50% hydrogenated saturated triglyceride.

In another embodiment, a method of making a plastic processing additive may include blending a hydrogenated saturated triglyceride with a second material to faun an additive composition. The method may also include pelletizing the additive composition.

In another embodiment, a pellet for plastics processing may be provided. The pellet may include a first component comprising a hydrogenated saturated triglyceride. The pellet may also include a second component comprising one of a wood product, a bioplastic, or a filler.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### DETAILED DESCRIPTION

In some embodiments, the present disclosure relates to compositions and methods including a low iodine value (“IV”) hydrogenated saturated triglyceride (“HST”) that is used in combination with bioplastics, plastics, and filled plastic composites. In some embodiments, the HST may be used with or without various plastic additives, fillers, or functional fillers. The HST may improve processing, it may provide lubrication, viscosity modification, VOC reduction, and, surprisingly, may provide for coupling of dissimilar materials. As such, the HST may allow for higher levels of filler additions to plastics and bioplastics. In addition, particular embodiments may be particularly helpful for processing moisture sensitive bioplastics such as PLA. For example, the step of predrying that is common with PLA, may be omitted. In still other adaptations, liquid blending of various mineral fillers, fibers, powders, additives, colorants, and other plastic additives may be used to create a master batch that can be processed with plastics, bioplastics or filled plastic materials.

In some embodiments, the HST may be a soy-based HST. Like known waxes, HST may assist with processing of plastics by reducing the shear levels in an extrusion process, for example, or reducing burn tendencies, for example. However, unlike other waxes, HST surprisingly may increase material coupling allowing for higher fill levels of the HST itself and/or other fillers providing for new ratios of materials and creating materials with enhanced physical, mechanical, and other properties.

Vegetable oils or animal fats hydrogenated to low or very low idodine values (IV), also known as iodine numbers, may be used alone or in blend formulations. The iodine values or numbers may be a measure of the iodine absorbed in a given time by a chemically unsaturated material, such as vegetable oil and is used to measure the unsaturation or number of double bonds of a compound or mixture. Examples of saturated triglycerides having a low iodine value (a range of iodine values of about 0-70 or even 0-30) may be produced by a hydrogenation of a commercial oil or fat such as oils of: soybean, soy stearine, stearine, corn, cottonseed, rape, canola, sunflower, fish, lard, tallow, palm, palm kernel, coconut, crambe, linseed, peanut, tall oil, animal fats, and blends thereof. These oils may be produced from genetically engineered plants to obtain low IV oil with a high percentage of fatty acid.

In some embodiments, HST in neat forms or blended with fillers, minerals, functional additives, colorants, fibers, plastics and other materials so that the HST or modified HST may be used for processing with bioplastics, wood plastics and conventional petrochemical based plastics to enhance processing, coupling, higher filler levels and/or change physical and mechanical properties.

Previously, expensive hydrocarbon and petrochemical-based coupling agents were used to improve the compatibility and coupling of dissimilar materials and fillers. In particular, such hydrocarbon and petrochemical-based coupling agents were separate from lubricants that were also petrochemical based. In contrast to the two-part system (i.e, petrochem lubricant/petrochem coupling agent) previously used, the present HST surprisingly provides both lubrication and hydrogenated coupling. HST from vegetable sources has the ability to couple materials based on hydrogenation of the vegetable oil and the remaining hydrogen bonding sites. As such, HST has the ability to couple minerals, fillers, fiber, plastics, rubbers, elastomers, plastic additives, and other materials into plastics and bioplastic materials. In some embodiments, HST may provide the following:
1. Mineral coating coupling
2. Coupling of wood with moisture resistance and lubrication
3. Coupling of rubbers and elastomers
4. Hydrogenated styrene replacement
5. Colorant compounds coupling
6. Binding of dissimilar materials
7. Adjustment of polymer properties

In addition to the coupling advantages mentioned, biobased materials such as HST may provide a low to no VOC solution that is annually renewable and petrochemical free. With new developments in bio-refining processes new types of materials are being generated as an environmentally friendly and annually renewable alternative for petrochemical processing. HST, for example, involves new processes for hydrogenated soybean oils creating this relatively new material. Embodiments of the present disclosure include new compositions, methods, and usages for these materials for plastics, filled plastics, and bioplastics.

Hydrogenated Saturated Triglycerides (“HST”) are produced from vegetable oils or animal fats. HST may be primarily produced from soybean oil, but may contain other non-soy ingredients. Soybean oil may be separated from solid components by solvent extraction or by mechanical pressing. The raw oil may be further refined and bleached and about 60 kg of soybeans may produce about 10 kg of soybean oil. The oil may then be hydrogenated to thicken it to a wax.

Hydrogenation includes a process whereby polyunsaturated and monounsaturated oils may be solidified in order to increase viscosity. The process involves reacting hydrogen with an oil at an elevated temperature, such as from approximately 140 degrees C. to approximately 225 degrees C., and in the presence of a nickel catalyst. Stirring the mixture may help to dissolve the hydrogen and to help to achieve a uniform distribution of the catalyst with the oil. The hydrogenation process may create saturated fats.

In some embodiments, low iodine number hydrogenated triglycerides such as those made available by Archer Daniels Midland (ADM) (Decatur, Ill.) under the product number designation ADM Vegetable Wax Product Code 866970 may be used. In other embodiments, Stable Flake S, manufactured by Cargill Incorporated (Wazata, Minn.), may be used. In still other embodiments, Master Chef Stable Flake-P palm oil wax, manufactured by Custom Shortenings & Oils (Richmond, Va.), may be used. In still other embodiments Marcus Nat 155, Marcus Nat 135, and Marcus Nat 125 soy bean waxes manufactured by Marcus Oil and Chemical Corp. (Houston, Tex.), may be used. Still other hydrogenated triglycerides or combinations of the triglycerides mentioned may be used.

The melting point of hydrogenated triglyceride may be quite low or extremely low relative to plastics or bioplastics. In some embodiments, the melting point of hydrogenated triglyceride may be below 212 degrees F., such that it may be melted by boiling water. As such, melting may be performed using a boiling water jacket or other controlled heat source. Once melted, the hydrogenated triglyceride may have a viscosity similar to that of water.

In its melted form, the hydrogenated triglyceride may be mixed with desired fillers, fibers, powders, minerals, colorants, plastics additives, or other materials. The materials may be blended with the liquid hydrogenated triglyceride at levels between 1% to 99% depending on particle sizes, bulk density, absorption rates and material type. The mixture may be mixed using standard mixing equipment or methods.

In one embodiment, a vegetable oil based hydrogenated triglyceride with a low iodine number (e.g., 1-60 IV and more preferably less than 20) may be melted and blended with one or more fillers. The melt may be solidified into a solid pellet, it may be used for densifying powders, and/or it may allow for improved liquid mixing of plastics fillers or additives. The viscosity of the molten hyrdrogenated triglyceride may be extremely low allowing for high loadings of wood, mineral, fibers, fillers, additives, or blends thereof The hydrogenation of the triglyceride also may help in the coupling of materials that typically do not couple well with plastic such as wood, minerals, starches, and other material solids. The liquid compounding process may have the ability to allow the molten hydrogenated triglyceride to impregnate or saturate into various hydrophilic materials to impart higher degrees of moisture resistance.

In some embodiments, as mentioned, a melted low iodine value/number hydrogenated triglyceride may be liquid mixed with various additives used in plastics or bioplastics and may be formed into a pellet for later use. Pellets may be later dry blended with various plastics pellets or bioplastics pellets during or prior to the plastic processes such as when it is extruded, film extruded, injection molded, blow molded, compression molded, or otherwise processed. Some “plastic additives” may include:
1. Mineral Fillers
2. Fire retardants
3. Biobased fillers (starch, proteins, hulls)
4. Agricultural fibers and flours
5. Wood fibers and flours
6. Cellulosic fiber and flours
7. Antioxidants, UV inhibitors, antimicrobial agents
8. Powdered thermoset or thermoplastics
9. Colorants (oxides, pigments, dyes)
10. Coupling agents (maleic acid, malic acid, citric acid, fumeric acid, etc.)
11. Blends thereof.

Blends of the above materials may be added to the molten hydrogenated triglycerides in ranges from fractions of a percent to 99% based on the needs of the final plastics products and ratios of this masterbatch.

The present invention may also include one or more additives. Suitable additives include one or more of dye, pigment, other colorant, hydrolyzing agent, plasticizer, filler, extender, preservative, antioxidants, nucleating agent, antistatic agent, biocide, fungicide, fire retardant, flame retardant, heat stabilizer, light stabilizer, conductive material, water, oil lubricant, impact modifier, coupling agent, crosslinking agent, blowing or foaming agent, reclaimed or recycled plastic, and the like, or mixtures thereof Suitable additives include plasticizer, light stabilizer, coupling agent, and the like or mixtures thereof In some embodiments, additives may be tailored to provide properties of the present biopolymer for end applications. In one or more embodiments, a biopolymer may include about 1 to about 90 percent by weight additive.

The material may be processed into pellets of sizes commonly used in the plastics industry. In some embodiments, the liquid mass (i.e., the HST and one or more additives) may be cooled and then granulated using a knife grinder. The granulated material may then be screened to provide particular sizes of particles. In another embodiment, a pelletizing process may be used and the material may be run through a rotating pellet mill based on the filler loading levels. Other methods of compounding and pelleting may be used. Embodiments of the present invention may be used with various minerals additives, fibers, fillers, colorants, and other materials blended with the HST to create a master batch pellet that can be blended with various plastics, wood plastics, filled plastics, or bioplastics to improve processing and various material attributes.

Several embodiments are described below where HST has been used to drastically improve processing of plastics or bioplastics. In each case, the particular advantages have been highlighted and surprising results relating to material coupling have allowed material combinations and ratios never before possible.

### Wood Products

Wood plastics are typically blends of plastics and wood in which the percentage of wood is fairly high and producers strive to gain higher percentages of wood in these composites for economic reasons. Processing of wood plastic lumber or composites has some inherent challenges due to the high wood loadings. For example, extrusion of wood plastic composites may create high shear in a plastic calling for high energy inputs and a need for lubricants to reduce the shear. In addition, high wood loadings may cause the end product to be subject to moisture absorption in exterior applications because there may be insufficient plastic to fully coat the wood particles. In addition, coupling agents are often used because wood and most plastics are not generally compatible. The lubricants and coupling agents commonly used include petrochemical-based products. Still other additives are often used.

In some embodiments of the present disclosure, wood plastic lumber and composites may include a blend of plastic and wood scrap that is used to produce an extruded linear shape or injection molded component, such as composite decking, railing, furniture, and the like. In some embodiments, plastics such as polyethylene, PVC, polypropylene and other common plastics or bioplastics may be used. The wood portion may include wood fiber, flour, cellulose, or paper mill sludge that may provide for a low cost fiber source that adds strength to the overall composite. The plastic may bind the matrix and provide a higher moisture resistance for the hydrophilic cellulosic based fibers. In some embodiments, these fibers may be added at a highest possible level due to being the lowest cost component.

In conjunction with the wood and plastic components, mentioned, HST may be provided. The HST may be molten and may be either sprayed directly onto the wood fiber to create a densified aggregate material, or it can be blended with various additives which can be directed added to the extrusion or injection molding process. In some embodiments, pre-manufactured pellets with specified amounts of HST and other additives may be used.

The HST may provide both a lubricant and a coupling agent or at least a lubricant without an anti-coupling effect. That is, the coupling ability of the HST may lower the need for a petrochemical-based coupling agent. The HST may also improve the moisture resistance of the wood fibers. Since the HST does not inhibit coupling, higher amounts of the HST may be used when compared to petrochemical lubricants. As such, addition ratios of HST in a neat form may range from 1% to over 10%. Blends of HST with various plastic additives may range from 1% to over 70% based on the form of plastic additive and desired results.

In some embodiments of the present disclosure wood flour plastics may be provided. In these embodiments, wood flour including a finely ground wood product may be provided that is derived from scrap wood which is processed to a small size typically that passes through a screen of a 20 US Standard Mesh Size. Wood flour is easily air borne and is very low in bulk density and may be difficult to process with heavy plastic pellets. In some embodiments, wood flour may be sprayed with HST to form an aggregate or it may be pelletized to form a pellet. This may be used as a master batch for plastics extrusion or injection molding processes allowing for the addition of a low cost wood-flour product. This may also increase the overall biobased content of the resulting plastic product.

### Bioplastics

Polylactic acid (“PLA”) is a highly engineered bioplastic. In comparing PLA to polyvinyl chloride (“PVC”), PLA has a higher stiffness (modulus of elasticity) compared to PVC yielding improved wear resistance and hardness. By reducing the stiffness by means of a plasticizer equal to that of PVC, we see very similar overall performance to PVC and improved performance in particular performance categories for indoor durable good component requirements. One aspect of the present disclosure may include a method for making PLA into a viable replacement for PVC.

Polylactic acid-based polymer may be selected from D-polylactic acid, L-polylactic acid, D,L-polylactic acid, meso-polylactic acid, and any combination thereof. In one embodiment, the polylactic acid-based material includes predominantly PLLA (poly-L-lactic acid). In one embodiment, the average molecular weight may be about 140,000, although a workable range for the polymer is between about 15,000 and about 300,000. In one or more embodiments, the PLA is L9000™. (Biomer, Germany).

Other forms of biopolymers included within embodiments of the present disclosure and derived from renewable resources includes polyhydroxyalkanoates (“PHA”). PHA polymers include polyhydroxybutyrates (“PHB”), polyhydroxyvalerates (“PHV”), and polyhydroxybutyrate-hydroxyvalerate copolymers (“PHBV”), polycaprolactone (“PCL”) (i.e., TONE), polyesteramides (i.e., BAK), a modified polyethylene terephthalate (“PET”) (i.e., BIOMAX), and “aliphatic-aromatic” copolymers (i.e., ECOFLEX and EASTAR BIO), mixtures of these materials and the like.

PLA may include some limitations such as poor viscosity and a lack of melt strength when the plastic is molten creating difficulties in processing. For example, PLA may be highly susceptible to hydrolysis and rapid degradation due to hydrolysis. Moisture, heat, pH, and high kinetic energy inputs can quickly break down the PLA polymer in a liquid, changing its viscosity to the point where it is difficult or impossible to process in extrusion. In addition, this hydrolysis leads to degradation of mechanical properties which can create a brittle material. Thus, common PLA processing requires pre-drying of the pellets prior to processing so that even very small percentages of moisture is removed to prevent hydrolysis during heat processing. Without more, moisture contents below 200 ppm are commonly thought to be needed to avoid molecular degradation and processing problems. In light of the above, processing PLA with many hydrophilic fillers creates numerous problems given that these fillers typically contain moisture leading to hydrolysis during heat process extrusion.

In addition, while processing PLA at or above its melting point, minerals such as calcium carbonate and forms of oxides creates issues with the chemistry of the PLA making it difficult or impossible to process at high loadings. The addition of liquids may also create issues with the chemistry and potentially lowering the molecular weight. In many cases the addition of most additives or fillers make the PLA even more brittle than its natural brittle amorphous state.

In some embodiments of the present disclosure various fillers or additives may be blended with HST prior to processing with the PLA. Surprisingly, the HST causes the PLA to be less sensitive to moisture and also the shear heat may be reduced or removed from the process allowing for faster processing and reduction of overall hydrolization of the PLA. The coupling ability of the hydrogenated material also helps in coupling of fillers that are difficult to blend with PLA also.

### Plastics and Filled Plastics

Filled plastics are commonly used to change performance of a standard plastic and/or to reduce cost. Fillers may be used to improve heat resistance, strength, and many other mechanical or physical properties of plastic to expand the available uses for plastics.

Fillers may include various groups such as minerals, fibers, flours, starches, proteins, synthetic fibers, cellulose, and many other types of fillers. In the case of most fillers, the addition of fillers may decrease the melt flows of plastics and may also require chemical coupling of these dissimilar materials.

A wide range of plastics materials are commonly used in filler applications including thermoactive materials including thermoplastic, thermoset material, a resin and adhesive polymer, or the like. As used herein, the term “thermoplastic” may refer to a plastic that can, once hardened, be melted and reset. As used herein, the term “thermoset” material may refer to a material (e.g., plastic) that, once hardened, cannot readily be melted and reset. As used herein, the phrase “resin and adhesive polymer” may refer to more reactive or more highly polar polymers than thermoplastic and thermoset materials.

Suitable thermoplastics include polyamide, polyolefin (e.g., polyethylene, polypropylene, poly(ethylene-copropyleno), poly(ethylene-coalphaolefin), polybutene, polyvinyl chloride, acrylate, acetate, and the like), polystyrenes (e.g., polystyrene homopolymers, polystyrene copolymers, polystyrene terpolymers, and styrene acrylonitrile (SAN) polymers), polysulfone, halogenated polymers (e.g., polyvinyl chloride, polyvinylidene chloride, polycarbonate, or the like, copolymers and mixtures of these materials, and the like. Suitable vinyl polymers include those produced by homopolymrization, copolymerization, terpolymerization, and like methods. Suitable homopolymers include polyolefins such as polyethylene, polypropylene, poly-1-butene, etc., polyvinylchloride, polyacrylate, substituted polyacrylate, polymethacrylate, polymethylmethacrylate, copolymers and mixtures of these materials, and the like. Suitable copolymers of alpha-olefins include ethylene-propylene copolymers, ethylene-hexytene copolymers, ethylene-methacrylate copolymers, ethylene-methacrylate copolymers, copolymers and mixtures of these materials, and the like. In certain embodiments, suitable thermoplastics include polypropylene (PP), polyethylene (PE), and polyvinyl chloride (PVC), copolymers and mixtures of these materials, and the like. In certain embodiments, suitable thermoplastics include polyethylene, polypropylene, polyvinyl chloride (PVC), low density polyethylene (LDPE), copoly-ethylene-vinyl acetate, copolymers and mixtures of these materials, and the like.

Suitable thermoset materials include epoxy materials, melamine materials, copolymers and mixtures of these materials, and the like. In certain embodiments, suitable thermoset materials Include epoxy materials and melamine materials. In certain embodiments, suitable thermoset materials include epichlorohydrin, bisphenol A, diglycidyl ether of 1,4-butanediol, diglycidyl ether of neopentyl glycol, diglycidyl ether of cyclohexanedimethanol, aliphatic; aromatic amine hardening agents, such as triethylenetetraamine, ethylenediamine, N-cocoalkyltrimethylenediamine, isophoronediamine, diethyltoluenediamine, tris(dimethylaminomethylphe-nol); carboxylic acid anhydrides such as methyltetrahydrophthalic anhydride, hexahydrophthalic anhydride, maleic anhydride, polyazelaic polyanhydride and phthalic anhydride, mixtures of these materials, and the like.

Suitable resin and adhesive polymer materials include resins such as condensation polymeric materials, vinyl polymeric materials, and alloys thereof. Suitable resin and adhesive polymer materials include polyesters (e.g., polyethylene terephthalate, polybutylene terephthalate, and the like), methyl diisocyanate (urethane or MDI), organic isocyanide, aromatic isocyanide, phenolic polymers, urea based polymers, copolymers and mixtures of these materials, and the like. Suitable resin materials include acrylonitrile-butadiene-styrene (ABS), polyacetyl resins, polyacrylic resins, fluorocarbon resins, nylon, phenoxy resins, polybutylene resins, polyarytether such as polyphenylether, polyphenylsulfide materials, polycarbonate materials, chlorinated polyether resins, polyethersulfone resins, polyphenylene oxide resins, polysulfone resins, polyimide resins, thermoplastic urethane elastomers, copolymers and mixtures of these materials, and the like. In certain embodiments, suitable resin and adhesive polymer materials include polyester, methyl diisocyanate (urethane or MDI), phenolic polymers, urea based polymers, and the like.

Suitable thermoactive materials include polymers derived from renewable resources, such as polymers including polylactic acid (PLA) and a class of polymers known as polyhydroxyalkanoates (PHA). PHA polymers include polyhydroxybutyrates (PHB), polyhydroxyvalerates (PHV), and polyhydroxybutyrate-hydroxyvalerate copolymers (PHBV), polycaprolactone (PCL) (i.e. TONE), polyesteramides (i.e. BAK), a modified polyethylene terephthalate (PET) (i.e. BIOMAX), and “aliphatic-aromatic” copolymers (i.e. ECOFLEX and EASTAR BIO), mixtures of these materials and the like

In some embodiments of the present disclosure embodiments are based on melt blending of a low iodine hydrogenated triglyceride derived from vegetable sources that is melt/mixed with various fillers, functional materials, additives and other materials used for the plastics and bioplastics industries in which the hydrogenated triglyceride provides lubrication, hydrogen coupling, improved moisture resistance, processing speed improvements, less energy inputs, reduction of VOC's, chemical modification, and other material functionality and processing advantages.

In keeping with the above, several different filler applications are described in more detail below highlighting the advantage of using HST in conjunction therewith.

BioAddition of Plastics—The addition of “biobased materials” to plastics is desired to increase the biobased content of plastics and provide less usage of petrochemicals. Materials such as starches, proteins, ground seed hulls, ground agricultural fibers, and other agricultural byproducts have been evaluated as a filler in plastics. These natural biobased material are highly sensitive to heat that can create a Mallard Reaction (browning and degradation), bad smell, or simply burn in processing at temperatures for plastics processing. In addition high shear or kinetic energy inputs also creates excessive heat that can degrade these natural materials quickly. Given the low melting point of the hydrogenated triglyceride, these biobased materials can be added at a wide range of ratios at temperatures lower than the Mallard Reaction temperature and with minimal heat mixing inputs. The masterbatch comprising of the solidified hydrogenated triglyceride with a biobased filler is then blended with normal plastics or bioplastic pellets and direct processed into extrusions, films or injection molding applications and components.

Additional bioaddition can be the blend of a hydrogenated triglyceride with a low iodine value blended with a powdered lignin as to provide the lignin lubrication and hydrogen coupling.

BioFiber Addition—The low iodine hydrogenated triglyceride can be blended with various hydrophillic fibers or flours derived from natural resources, including blended with natural fibers and other similar forms of hydrophilic fibers. This, in addition to its organic nature, provides both higher degrees of wear resistance and improves char promotion in creating fire rated laminates and matching profile extrusion components. Natural fiber materials may include, but not limited to: wheat straw, soybean straw, rice straw, corn stalks, hemp, baggase, soybean hulls, oat hulls, corn hulls, sunflower hulls, paper mill waste, nut shells, cellulosic fiber, paper mill sludge, and other agriculturally produced fibers. Wheat and rice fiber may be preferred for their shiny surfaces wherein these types of fiber are uniquely ground into long narrow strands and not into a fine filler powder as typically done in wood plastic composites.

Fire Retardant Plastics—Fire retardants such as ATH, various magnesium FR's, intumescents and phosphorous based FR materials are typically in their raw form are in the forms of powders. The addition of a FR material to burnable plastics is of importance for various plastics applications. Hydrogenated Triglycerides in this invention can be either sprayed on the surface of the powdered fire retardant or liquid blended based on the ratio requirements. Also halogen-free flame retardants can be used. Typical flame-retardants are P-based flame retardants as organic phosphates (e.g. P(.dbd.O)(OR1)(OR2)(OR3) etc), phosphonates (e.g. R-P(.dbd.O)(IR1(OR2) etc), phosphinates (e.g. R1,R2-P(.dbd.O)(OR3) etc, phosphine oxides (e.g. R1,R2,R3-P(.dbd.O) etc) as well as the corresponding phosphate, phosphonate and/or phosphinate salts of these P-compounds. Besides P-based flame retardants also N-containing compounds can be used like triazine derivatives as melamine cyanurate, melamine (pyro or poly)phosphales, etc. Also other compounds as Zn-borates, hydroxides or carbonates as Mg- and/or AI-hydroxides or carbonates, Si-based compounds like silanes or siloxanes, Sulfur based compounds as aryl sulphonates (including salts) or sulphoxides, Sn-compounds as stannates can be used as well often in combination with one or more of the other possible flame retardants.

Mineral Filled Plastics.—Various minerals ranging from quartz, calcium carbonates, clay, talc, silica, and various other minerals commonly used for plastics fillers can be liquid blended with the hydrogenated triglyceride in ranges from 1% to 90% and more preferable between 50% to 80% that can be used as a master batch composition pellet that is added to standard bioplastics or plastics to improve mechanical and heat resistant properties.

Metal Powders—Metal powders can be added to plastics to increases is specific gravity, provide decorative effects, provide electrical conductivity, or other functional needs. Metal powder are derived from a wide range of metals including, but not limited to aluminum, steel, carbide, and others.

Colorants—Many plastic colorants are based on a powdered oxide for various plastics. Blends of the low iodine hydrogenated triglyceride can be melt blended with various colorants including, but not limited to: Suitable inorganic colorants, such as ground metal oxide colorants of the type commonly used to color cement arid grout. Such inorganic colorants include, but are not limited to: metal oxides such as red iron oxide (primarily Fe.sub.20.sub.3), yellow iron oxide (Fe.sub.20H0), titanium dioxide (TiO.sub.2), yellow iron oxide/titanium dioxide mixture, nickel oxide, manganese dioxide (MnO.sub.2), and chromium (III) oxide (Cr.sub.20.sub.3); mixed metal rutile or spinet pigments such as nickel antimony titanium rutile ({Ti,Ni,Sb)O.sub.2), cobalt aluminate spinet (CoAl.sub.20,sub.4), zinc iron chromite spinet, manganese antimony titanium rutile, iron titanium spinet, chrome antimony titanium ruffle, copper chromite spinet, chrome iron nickel spinet, and manganese ferrite spinet; lead chromate; cobalt phosphate (CO.sub.3(PO.sub.4).sub.2); cobalt lithium phosphate (CoLiPO.sub.4); manganese ammonium pyrophosphate; cobalt magnesium borate; and sodium atumino sulfosilicate (Na.sub.6Al.sub.6Si.sub.60.sub.24S.sub,4). Suitable organic colorants include, but are not limited to: carbon black such as lampblack pigment dispersion: xanthene dyes; phthalocyanine dyes such as copper phthalocyanine and polychloro copper phthalocyanine; quinacridone pigments including chlorinated quinacridone pigments; dioxazine pigments; anthroquinone dyes; azo dyes such as azo naphthalenedisulfonic acid dyes: copper azo dyes; pyrrolopyrrol pigments; and isoindolinone pigments. Such dyes and pigments are commercially available from Mineral Pigments Corp. (Beltsville, Md.), Shepherd Color Co. (Cincinnati, Ohio), Tamms Industries Co. (Itasca, Ill.), Huts America Inc. (Piscataway. N.J.). Ferro Corp. (Cleveland, Ohio), Engelhard Corp. (Iselin, N.J.), BASF Corp. (Parsippany, N.J.), Ciba-Geigy Corp. (Newport, Del.), and DuPont Chemicals (Wilmington, Del.)

Filler Viscosity MODIFICATION Agents—Plastic has a melt index which measures is viscosity at a specific melt temperature and pressure. The addition of most all fillers, fibers, minerals or other “non flowing” materials greatly increases the viscosity of the plastic, especially in highly filled systems. In addition to simply plasticization or viscosity modification it is important to also maintain coupling of the non flow materials to the plastic.

Hydrogenated Triglycerides with a low iodine number can be added at a specific ratio to the filler wherein the end viscosity or melt index is the same as the starting neat plastic due to the fact that the molten HST is at a similar viscosity of water at these specific processing temperatures.

Maleated or Coupling Hydrogenated Triglycerides—A maleated saturated hydrogenated triglyceride wherein the hydrogenated triglyceride has a low iodine number. The maleated hydrogenated triglyceride (MHT), is in a pellet form that can be added to plastics, bioplastics and wood plastic composite to impart coupling, moisture resistance, improved processing, and hydrogen coupling.

Biobased Natural Coupling Agents—Low iodine hydrogenated triglycerides can be blended with natural coupling agents such as citric acid, lactic acid, fumeric acids, and mate acids to provide an all-natural solution for coupling bioplastics or add biocontent to normal petrochemical plastics.

In one or more of the above situations, the resulting plastic composition or compound may be molded into useful articles such as by injection molding, extrusion molding, rotation molding, foam molding, calendar molding, blow molding, thermoforming, compaction, melt spinning and the like, to form articles. Suitable articles are exemplified but are not limited to exterior and interior components of aircraft, automotive, truck, military vehicles, boats, hover crafts, scooters, motorcycles, and the like. For example, such components may include panels, quarter panels, rocker panels, trim, fenders, doors, decklids, trunk lids, hoods, bonnets, roofs, bumpers, fascia, grilles, minor housings, pillar appliques, cladding, body side moldings, wheel covers, hubcaps, door handles, spoilers, window frames, headlamp bezels, headlamps, tail lamps, tail lamp housings, tail lamp bezels, license plate enclosures, roof racks, and running boards. Still other components may be provided. Additional components may include enclosures, housings, panels, and parts for outdoor vehicles and devices. Still other components may include enclosures for electrical and telecommunication devices, indoor and/or outdoor furniture, aircraft components. Still other components may include boats and marine equipment, including trim, enclosures and housings, outboard motor housings, depth finder housings, personal watercraft, jet-skis, pools, spas, hot tubs, steps, step coverings and the like. Still other applications include buildings and construction applications such as glazing, roofs, windows, floors, decorative window furnishings or treatments. Additional components may include treated glass covers for pictures, paintings, posters and like display items. Still other components may include wall panels, doors, counter tops, protected graphics, outdoor and indoor signs. Still other components may include enclosures, housings, panels, and parts for automatic teller machines (ATM). Still other components may include desktop computers, portable computers, laptop computers, palm, handheld or other smartphone housings and the like. Other computer components may include monitors, printers, keyboards, fax machines copiers, telephones, phone bezels, mobile phones, radio senders, radio receiver, enclosures for housings panels, parts for lawn and garden tractors, lawn mowers and tools such as lawn and garden tools or other tools. Additional components may include window and door trim, sports equipment and toys. Additional components may include enclosures, housings, panels, and parts for snowmobiles. Additional components may include recreational vehicle panels and components. Additional components may include playground equipment, shoe laces, articles made from plastic-wood combinations, golf course markers, utility pit covers, light fixtures, lighting appliances, network interface device housings, transformer housings, air conditioner housings, cladding or seating for public transportation including buses, subways, or trains, meter housings, antenna housings, cladding for satellite dishes, coated helmets and personal protective equipment, coated synthetic or natural textiles, coated painted articles, coated dyed articles, coated fluorescent articles, coated foam articles and like applications. In some embodiments, additional fabrication operations on articles may include molding, in-mold decoration, baking in a paint oven, lamination and/or thermoforming.

Some particular examples of blends may be provided as follows with particular names.

A biohydrogenated plastic or biolistic may be provided and the HST may provide hydrogenated coupling within the plastic/bioplastic or filled plastic/bioplastics. As mentioned, the HST may be derived from a low iodine value hydrogenated triglyceride where the HST is derived from a vegetable oil. In some embodiments the iodine level may be between 0-50 or 0-30. The HST may be blended with plastics or bioplastics in a range from 0.5% to 50% and the blending may occur in a compounding, extrusion or injection molding process. In some embodiments, the HST may be blended with lactic acid prior to polymerization to create a hydrogenated bioplastics.

In some embodiments, a biohydrogenated plastic additive may include one or more of dye, pigment, hydrolyzing agent, plasticizer, filler, preservative, antioxidants, nucleating agent, antistatic agent, biocide, fungicide, fire retardant, flame retardant, heat stabilizer, light stabilizer, conductive material, water, oil, lubricant, impact modifier, coupling agent, crosslinking agent, blowing or foaming agent, reclaimed or recycled plastic, agricultural fiber, starch, protein, wood fiber, wood flour, papermill sludge.

Such an additive may be compounded with a plastic, bioplastic or petrochemical plastic. In some embodiments, a master batch according to the above, may be further blended with a plastic or bioplastic.

In some embodiments, a wood or agrifiber plastic composite may include wood, plastic, and a low iodine number HST. Here, again, the HST may provide coupling and may also improve the moisture resistance of the wood. In some embodiments, the wood plastic may be extruded and may be a deck board, window, or door component. The HST may provide lubrication and may include an additional maleic acid/anhydride.

In some embodiments, as mentioned a process of melt blending a low iodine number HST with various powdered plastics additives, fillers or functional fillers may be provided where the compound is then solidifying into a pellet.

In some embodiments, an HST pellet may include:
1. Fire retardant
2. Coupling agent
3. Mineral Filler
4. Biobased Filler
5. Cellulose filler
6. Plastic additive
7. Colorant
   In some embodiments, the ratio of filler may range from 1% to 99%. For example, in some embodiments, the fillers in a given composition may be as follows:

Fire retardant may be present from about 50-90%.

a coupling agent may be present at about 50% or more.

a biobased filler may be present at about 50% or more.

Each of the above may be blended with HST pellets as described herein. Typically the filler(s) will be present at 50% or more relative to the HST. The pellet and filler blend may then be blended with one or more plastic or bioplastic during processing, typically at ratios of less than about 50%. It will be understood however that other ratios are possible and are within the scope of the present disclosure.

In some embodiments, a low iodine value HST may be blended with a mineral filler ranging from 1% to 95% and the mineral may be a quartz, silica, calcium carbonate, clay, other minerals, or combination thereof In some embodiments, the HST and mineral compound may be in a pellet form and the pellet may be used in combination with bioplastics or plastics. In some embodiments, the bioplastic may be PLA, PHA, or other bioplastics.

In some embodiments, a low iodine value HST may be blended with a fire retardant ranging from 20% to 95% fire retardant. In some embodiments, the fire retardant may be an intumescent fire retardant. In other embodiments, the fire retardant may be a Mag hydrox, alumium tyhydrate, or phosphorous type. In some embodiments, additional powder fillers can be added. In some embodiments, the HST/fire retardant may be in a pellet form and may be used in combination with a bioplastic or plastic.

In some embodiments, a low iodine value HST may be blended with a biobased filler such as those that follow:
1. Wood fiber/flour
2. Agricultural fiber/flour
3. Starch
4. Protein
5. seed hull flour or fiber
6. cellulose
7. Others

In some embodiments, a low iodine value HST may be blended with a coupling agent such as the following:
1. Maleic Acid/Meleic anhydride
2. Citric acid, lactic acid, fumeric acid, malic acid. In some embodiments, additional fillers or blends may be added.

In some embodiments a biohydrogenated coupling and plasticization additive for plasticizing PVC may be provided. In some embodiments, this may be done by reacting a low iodine value HST from vegetable oil with a PVC.

Additional examples may include:
1. Wood plastics Lumber
2. Wood Bioplastic Lumber
3. PLA bioplastics alloys and ranges (Speed, energy, drying, high loadings)
4. PVC Wood plastic
5. PLA/Petroplastic blends
6. Saturated Fibers
7. Starched Filled
8. Protein Filled
9. Intumescent Fire retardant filled
10. Coupling Agent Filled
11. Colorant Filled (PLA/HySoy/Tio2):

Additional examples may include HST in combination with one or more of the following:
1. Coupling Agents
2. Maleic Acid, Maleic Anhydride, Fumeric Acid, etc
3. Citric Acid, Malic Acids
4. Acid Proteins
5. BioFilled
6. Wood flour and fiber
7. Agricultural cellulose fiber and flours
8. Starch, Proteins
9. Seed Hull Fiber
10. Fire Retardants
11. Intumescents
12. Mag Hydrox
13. Alum Hydrox
14. Phosphorous
15. Colorants
16. Pigments, oxides, dyes, etc
17. Metal Powders
18. Plastic Powders
19. Powder Coating Plastics
20. Thermoset and thermoplastics
21. Synthetic Fibers
22. Carbon, fiberglass, Kevlar
23. Micro Additives
24. Antioxidants, antimicrobial, UV inhibitors.

Hydrogenated Triglyceride Polymers (HTP)

Embodiments of the present invention also include the ability to “hydrogenate” various plastics commonly used in profile extrusion, film extrusion, injection molding, blow molding, and other common thermoplastics applications.

Hydrogenated Trigylceride Polymer having a low iodine value (IV) between 0-50 and more preferably less than 30 may be blended with various thermoplastics such as polyethylene, polypropylene, PVC, and other plastics or blends of plastics. The Hydrogenated Triglyceride Polymer (HTP) may provide a chemical coupling and modification to the plastics and bioplastics applications.

Low level blends of HST and associated hydrogenation levels may be more compatible with polar polymers such as vinyls, PVC, EVA. Higher levels of HST and hydrogenation will be more compatible with non polar plastics such as polyolefins and styrene.

HTP may include a low iodine value HST derived from a vegetable oil through a hydrogenation process and metal catalyst polymerization process.

HTPs can be used for a wide range of applications and benefits including lower VOC content, increased biobased content, lower costs raw materials, coupling agents, plastics modifications, and other applications.

Blends of the low iodine value HST compounded with various plastics (HIP) can range from a 1% addition to addition rates over 50% based on the final need of the polymer.

PVC HTP's & Plasticized HTP's

PVC or polyvinyl chlorides are a commonly used rigid plastics. Petrochemical plasticiziers are commonly used, but contain cancer causing and toxic materials.

HST can be blended with PVC or filled PVC in which low addition levels provides hydrogenated coupling, lubrication and other material and processing benefits. At high level loadings (5% to 50%), the HST provides a hydrogenated plasticization effect to soften the PVC creating a highly stable flexible PVC and also allow for coupling of additional materials, fillers, or additives.

In some embodiments, a composition of higher loadings of a low iodine value hydrogenated triglyceride may be reacted with a PVC to create coupling and plasticization (flexibility or softening) of the PVC.

PLA and Bioplastic HTP's

Polylactic Acid is the leading bioplastic. Currently PLA's are a hard and brittle material with various processing limitations. Blending of an HT with a PLA provides for a material that has improved impact resistance, improved flexibility and other material attributes. The Hydrogenated PLA blends the HST with PLA at various ratios from 0.2% to 50% based on the requirements of hydrogenation, processing requirements and final material performance requirements. This also allow for easier blending of minerals or powder additives given the hydrolization problems with PLA due to moisture and that these minerals, powders, and additives typically have a higher moisture content.

In some embodiments, a composition may be formed by compounding a low iodine value HST with a biopolymer to create a hydrogenated biopolymer.

Biopolymers or blends thereof may be selected from the following: DL-polylactide (DLPLA), D-polylactide (DPLA), L-polylactide (LPLA), polyglycolide (PGA), poly(DL-lactide-co-glycolide) (PGLA), poly(ethylene glycol-co-lactide), polycaprolactone (PCL), poly(L-lactide-co-caprolactone-co-glycolide), poly(dioxanone) (PDO), poly(trimethylene carbonate), polyglyconate, polyhydroxyalkanoates (PHA), polyhydroxybutyrate (PHB), polyhydroxybutyrate-co-hydroxyvalerate (PHBV), polyhydroxyvalerate (PHV), polysaccharides, modified polysaccharides, aliphatic and aromatic copolyesters, poly(1,4-butylene succinate) (PBS), poly(1,4-butylene adipate) (PBA), (poly butadiene adipate co-terephthalatc polymer (PBAT), poly(butylene succinate adipate) (PBSA), polyanhydrides, polyorthoesters (POE), plasticized starch with poly(caprolactone), starch-based aliphatic polyesters, polyestcramides (PEA).

Polyolefin HTP's

A low iodine value hydrogenated triglyceride can be reacted with various polyolefins including polyethylene, polypropylene, and other forms of polyolefins as to impart hydrogenation and hydrogen coupling along with polymer modification.

Polyolefins are generally difficult to couple with various other fillers, minerals, and additives. The ability to hydrogenate the polyolefin by simply reacting an HST at various ratios provides a low cost and novel method to hydrogenate polyolefins and also provides viscosity modification for improved filler and additive additions to polyolefins used in extrusion, injection molding, blow molding and other polyolefin thermoplastic processes and materials.

TPE HTP's

Thermoplastic elastomers (TPE), sometimes referred to as thermoplastic rubbers, are a class of copolymers or a physical mix of polymers (usually a plastic and a rubber) which consist of materials with both thermoplastic and elastomeric properties. While most elastomers are thermosets, thermoplastics are in contrast relatively easy to use in manufacturing, for example, by injection molding. Thermoplastic elastomers show advantages typical of both rubbery materials and plastic materials. The principal difference between thermoset elastomers and thermoplastic elastomers is the type of crosslinking bond in their structures. In fact, crosslinking is a critical structural factor which contributes to impart high elastic properties

Rubbers can be reacted with various plastics such as styrene, polyolefins, polyesters and other. In these cases a coupling agent is often required to provide coupling of the rubber to various polymers and retain the flexible nature of the elastomer.

In some embodiments, where a low iodine value HST is combined with a combination of a plastic and rubber, the HST may provide coupling, plasticization, and stabilization of the TPE. In addition this provides a biocontent to the material to lessen its environmental chemical impact.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an ingredient or element may still actually contain such item as long as there is generally no measurable effect thereof.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A plastic composition, comprising:
a plastic or bioplastic portion; and
about 0.5%-50% hydrogenated saturated triglyceride.

2. The plastic composition of claim 1, wherein the composition comprises about 10-50% hydrogenated saturated triglyceride.

3. The plastic composition of claim 2, wherein the composition comprises about 50% hydrogentated saturated triglyceride.

4. The plastic composition of claim 1, further comprising a filler.

5. The plastic composition of claim 4, wherein the composition comprises about 5-70% filler.

6. The plastic composition of claim 3, wherein the composition comprises about 50 percent filler.

7. The plastic composition of claim 5, wherein the composition comprises 2-25 percent hydrogenated saturated triglyceride.

8. The plastic composition of claim 1, wherein the hydrogenated saturated triglyceride is a low iodine value hydrogenated saturated triglyceride.

9. The plastic composition of claim 8, wherein the low iodine value is from about 0-50.

10. The plastic composition of claim 8, wherein the hydrogenated saturated triglyceride is derived from vegetable oil.

11. The plastic composition of claim 10, wherein the vegetable oil is soybean oil.

12. The plastic composition of claim 2, wherein the plastic or bioplastic portion is polylactic acid.

13. A method of making a plastic processing additive, comprising:
blending a hydrogenated saturated triglyceride with a second material to form an additive composition; and
pelletizing the additive composition.

14. The method of making of claim 13, wherein the second material is selected from the group consisting of fire retardant, coupling agent, mineral filler, biobased filler, cellulose filler, plastic additive, natural or synthetic fiber, and colorant.

15. The method of making of claim 13, wherein the second material is a flour additive.

16. The method of making of claim 15, wherein blending the hydrogenated saturated triglyceride with a second material comprises spraying the flout additive with the hydrogenated saturated triglyceride.

17. The method of claim 13, wherein the hydrogenated saturated triglyceride comprise a low iodine value.

18. The method of claim 17, wherein the hydrogenated saturated triglyceride is derived from vegetable oil.

19. A pellet for plastics processing, comprising:
a first component comprising a hydrogenated saturated triglyceride; and
a second component comprising one of a wood product, a bioplastic, or a filler.

20. The pellet of claim 19, wherein the hydrogenated saturated triglyceride comprises a low iodine value.
